(19) United States
(12) Patent Application Publication
(10) Pub. No.: US 2014/0375668 A1
(43) Pub. Date: Dec. 25, 2014

(54) LOOKUP-TABLE-BASED GREEN IMBALANCE CORRECTION SYSTEM AND METHOD

(71) Applicant: Himax Imaging Limited, Tainan City (TW)

(72) Inventor: Yen-Te Shih, Tainan City (TW)

(21) Appl. No.: 13/924,493

(22) Filed: Jun. 21, 2013

(51) Int. Cl. G06T 11/00

(52) U.S. Cl. CPC G06T 11/001
USPC 345/589

(57) ABSTRACT

In a lookup-table-based green imbalance correction system and method, an image sensor with a color filter array placed thereover outputs raw data. A green imbalance correction device corrects the raw data according to a lookup table stored in a memory, thereby resulting in corrected raw data. A color interpolation device receives the corrected raw data to result in full-color data.

### BACKGROUND OF THE INVENTION

1. Field of the Invention

The disclosure generally relates to green imbalance, and more particularly to a lookup-table-based green imbalance correction system and method for an image sensor.

2. Description of Related Art

A Bayer color filter array (CFA) is commonly used in companion with an image sensor, such as a complementary metal-oxide-semiconductor (CMOS) image sensor, to capture color information. One of the disadvantages of the CMOS image sensor is that a gain of a green pixel (Gr) in a line with red pixels usually differs from a gain of a green pixel (Gb) in a line with blue pixels. This gives rise to green imbalance or mismatch. Some common causes of the green imbalance may be layout of photo diode, non-uniformity of a color filter array, lens coating and mounting, and mismatched amplifiers. Therefore, overall green imbalance is ordinarily location dependent and non-uniform. The green imbalance results in lines or cross hatched patterns that are annoying and cannot be negligible.

Conventional methods of overcoming the green imbalance are either computation intensive or incapable of adapting to an electronic apparatus with newly assembled components (e.g., lens).

For the foregoing reasons, a need has arisen to propose a novel scheme of correcting green imbalance in a flexible and fast manner.

### SUMMARY OF THE INVENTION

In view of the foregoing, it is an object of the embodiment of the present invention to provide a lookup-table-based system and method for correcting green imbalance. A lookup table utilized in the embodiment may be flexibly adapted to an electronic apparatus with different assembled components. One embodiment further corrects green imbalance by taking into consideration the location of pixels under processing.

According to one embodiment, a lookup-table-based green imbalance correction system includes an image sensor with a color filter array placed over the image sensor, a memory, a green imbalance correction device and a color interpolation device. The image sensor is configured to output raw data, and the memory is configured to store a lookup table. The green imbalance correction device is configured to correct the raw data according to the lookup table, thereby resulting in corrected raw data. The color interpolation device is coupled to receive the corrected raw data to result in full-color data.

### BRIEF DESCRIPTION OF THE DRAWINGS

FIG. 1 shows a block diagram illustrative of a lookup-table-based green imbalance correction system according to one embodiment of the present invention;

FIG. 2 shows a pattern of a Bayer CFA;

FIG. 3 shows an exemplary 3×3 process mask;

FIG. 4 shows a flow diagram illustrative of a method of determining weights associated with neighboring green pixels; and

FIG. 5 shows exemplary weights associated with multiple sections into which the obtained difference diff is located.

### DETAILED DESCRIPTION OF THE INVENTION

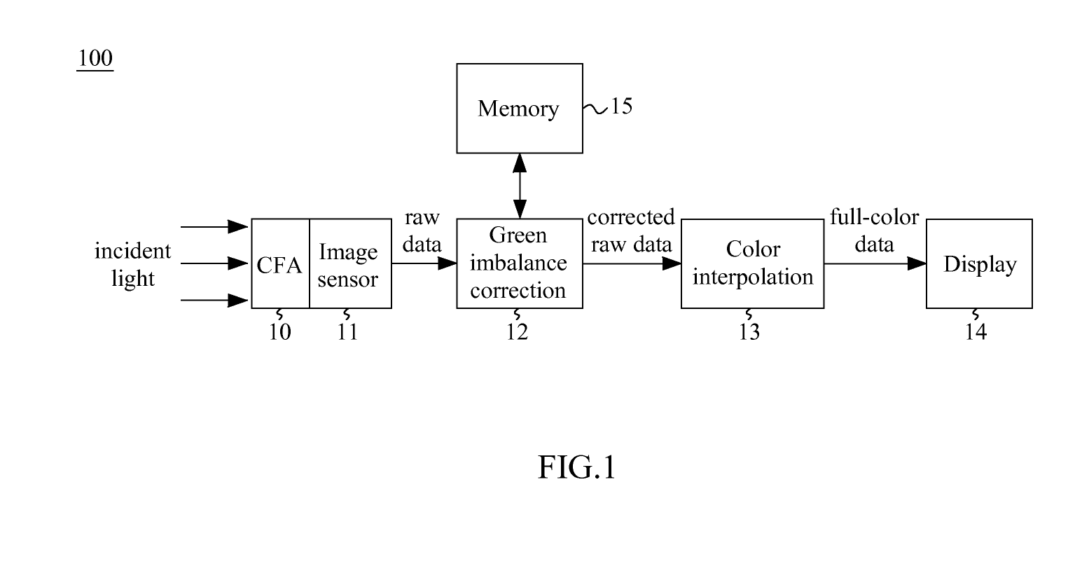

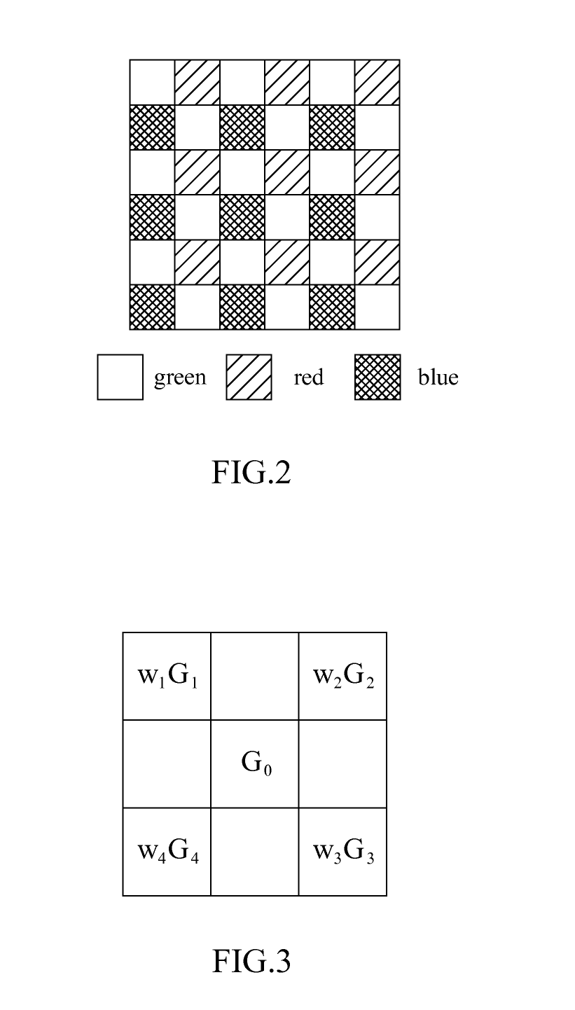

FIG. 1 shows a block diagram illustrative of a lookup-table-based green imbalance correction system 100 according to one embodiment of the present invention. The system 100 of the embodiment includes an image sensor 11 (e.g., a complementary metal-oxide-semiconductor (CMOS) image sensor) with a color filter array (CFA) or color filter mosaic (CFM) 10, such as a Bayer CFA, placed over the image sensor 11, therefore outputting raw data. FIG. 2 shows a pattern of the Bayer CFA, which has 50% of green filters, 25% of blue filters and 25% of red filters. In other words, each two-by-two sub-array contains two green filters, one blue filter and one red filter. The color filters filter an incident light by wavelength range such that the outputted raw data give information about intensity of light in red, green and blue (RGB) wavelength regions.

Before the raw data are subjected to interpolation, by a color interpolation device 13, to result in full-color data that may, for example, be presented on a display device 14 (such as a liquid crystal display), the raw data in the embodiment are furthermore corrected by a green imbalance correction device 12, therefore generating corrected raw data which are rendered with substantially low amount in green imbalance. The green imbalance correction device (“correction device” for short) 12 and/or the color interpolation device 13 may be part of an image signal processor (ISP), or be implemented in hardware and/or software operated under control of the ISP. According to one aspect of the embodiment, a memory 15 is employed to store a lookup table that may be utilized by the correction device 12 to perform green imbalance correction, hence resulting in the lookup-table-based green imbalance correction system 100. The lookup table and its cooperation with the correction device 12 will be detailed in the following paragraphs.

FIG. 3 shows an exemplary 3×3 process mask (or window) that passes over and processes an image made of the raw data in an order, for example, from top to bottom and from left to right. A current green pixel G₀ is located at a center of a center line, a top line including G₁ and G₂ is passed (or processed), and a bottom line including G₃ and G₄ is non-passed (or non-processed). In the embodiment, a corrected current green pixel may be expressed as summation of weighted neighboring green pixels (e.g., G₁, G₂, G₃ and G₄) and the uncorrected current green pixel G₀. The weights (w₁ to w₄) associated with the neighboring green pixels may be looked up from the lookup table stored in the memory 15. Although the current green pixel G₀ as shown in FIG. 3 is not weighted, it is appreciated that, in another embodiment, a weight (e.g., w₀) may be associated with the current green pixel G₀. Moreover, the corrected current green pixel may be expressed further using a strength that is dependent on a location of the process mask within the image. An exemplary expression of the corrected current green pixel G′₀ with a weight wᵢ (i=1 to 4) and a strength str is shown below:

$${G}_{0}^{′} = \frac{256 \times {G}_{0} + \frac{str \times {\sum }_{i = 1}^{4} {w}_{i} {G}_{i}}{64}}{256 + \frac{str \times {\sum }_{i = 1}^{4} {w}_{i}}{64}}$$

where str is within 0 and 255, and wᵢ is within 0 and 255.

As exemplified in the expression above, the neighboring green pixels Gᵢ are first weighted using (that is, multiplied by) associated weights wᵢ, respectively, and the weighted neighboring green pixels, as a whole, are thereafter adjusted by the strength str.

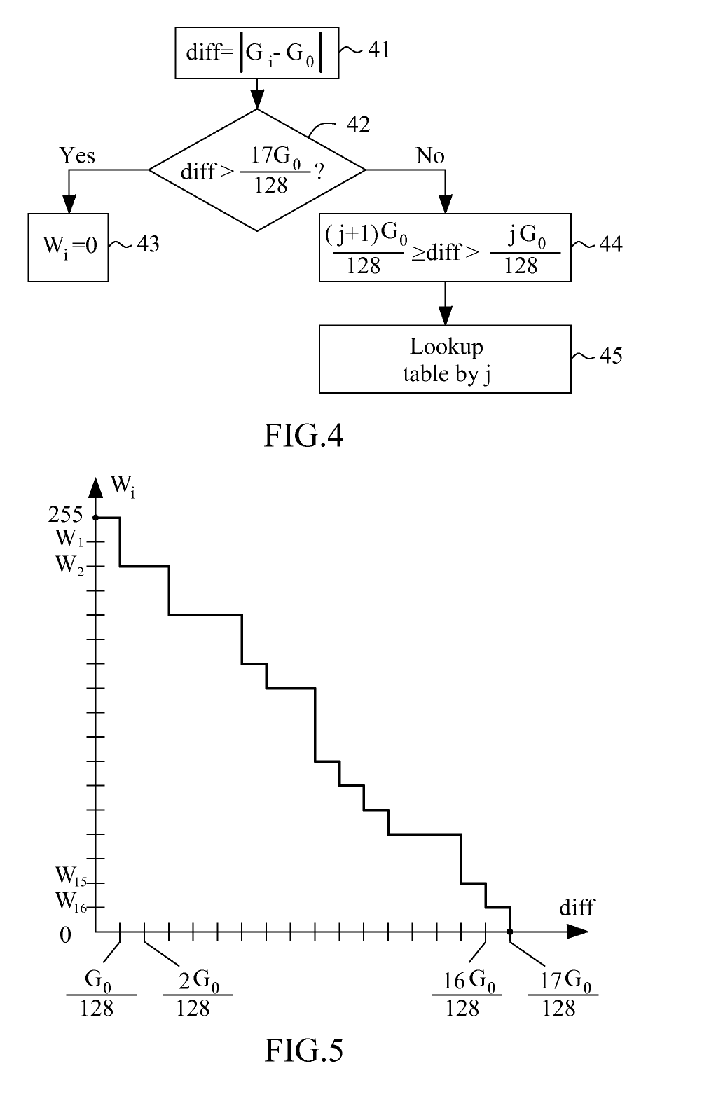

In the embodiment, the weights wᵢ associated with the neighboring green pixels G₁-G₄ are determined according to their differences (or distances) with the current green pixel G₀ respectively, that is, |Gᵢ-G₀| (i=1 to 4). FIG. 4 shows a flow diagram illustrative of a method of determining the weights w, associated with neighboring green pixels Gᵢ. In step 41, a difference diff=|Gᵢ-G₀| between a neighboring green pixel Gᵢ and the current green pixel G₀ is obtained. Subsequently, in step 42, the obtained difference diff is compared with a predetermined difference threshold (e.g., 17 G₀/128). If the obtained difference diff is greater than the difference threshold, zero is then assigned to the weight wᵢ (step 43). Otherwise, in step 44, it is determined a section (jG₀/128, (j+1)G₀/128], i.e., jG₀/128<diff≦(j+1)G₀/128, into which the obtained difference diff is located. FIG. 5 shows exemplary weights w₁-w₁₆ associated with multiple sections within (G₀/128, 2G₀/128, . . . , 17 G₀/128]. Generally speaking, the larger the difference is, the lower the weight is, and vice versa. According to a determined index j associated with the section (jG₀/128, (j+1)G₀/128] where the obtained difference diff is located, a corresponding weight wⱼ may then be obtained from the lookup table stored in the memory 15 (step 45). Although the weight curve exemplified in FIG. 5 is decreasing, however, the weight curve may, for example, be decreasing in part and increasing in part. As the flow illustrated in FIG. 4 is adapted for processing a current green pixel, a current blue or red pixel in the embodiment may be bypassed. That is, the current blue or red pixel of the raw data from the image sensor 11 is directly subjected to interpolation by the color interpolation device 13. It is noted that, in the embodiment, the weights may be obtained and then stored in the memory 15 after an electronic apparatus, such as a camera, employing the system 100 has been calibrated. No need for changing the weights may be required unless, for example, another type of lens and/or image sensor 11 is newly used. Compared with conventional methods of correcting green imbalance, the present embodiment adopting the lookup table provides a flexible scheme that can easily adapt to an electronic apparatus with newly assembled components (e.g., lens).

As described above, the corrected current green pixel may be expressed as summation of weighted neighboring green pixels and the uncorrected current green pixel, and the summation may further be adaptively adjusted in considerations of the location of the process mask within the image. Specifically, in the embodiment, the strength may be determined according to (e.g., be proportional to) a distance between a center (i.e., the current green pixel G₀ of the process mask and a prime point of the image made of the raw data. For example, the larger the distance is (that is, near a boundary of the image), the larger the strength is, and vice versa. In the embodiment, the strengths associated with distances may be derived according to parameters stored in the memory 15 and according to corresponding distances. The strengths may thus be derived in real time. No need for changing the strengths may be required unless, for example, another image resolution is configured. The prime point may, but not necessarily, be a center of the image. For example, the prime point may be associated with a focal point of a lens that is deliberatively or unintentionally deviated from a center of the image.

Although specific embodiments have been illustrated and described, it will be appreciated by those skilled in the art that various modifications may be made without departing from the scope of the present invention, which is intended to be limited solely by the appended claims.

What is claimed is:

1. A lookup-table-based green imbalance correction system, comprising:
an image sensor with a color filter array placed over the image sensor configured to output raw data;
a memory configured to store a lookup table;
a green imbalance correction device configured to correct the raw data according to the lookup table, thereby resulting in corrected raw data; and
a color interpolation device coupled to receive the corrected raw data to result in full-color data.

2. The system of claim 1, wherein the color filter array comprises a Bayer color filter array.

3. The system of claim 1, further comprising an image signal processor that encompasses the green imbalance correction device and/or the color interpolation device; or controls operations of the green imbalance correction device and/or the color interpolation device.

4. The system of claim 1, wherein a current green pixel of the raw data to be currently processed within a process mask to result in a corrected current green pixel is expressed as summation of weighted neighboring green pixels and the current green pixel before being processed, weights associated with the neighboring green pixels within the process mask being looked up from the lookup table.

5. The system of claim 4, wherein the weights associated with the neighboring green pixels are determined according to their differences with the current green pixel, respectively.

6. The system of claim 5, wherein the larger the difference is, the lower the weight is, and vice versa.

7. The system of claim 6, wherein the weight associated with the neighboring green pixel is determined in the following steps:
obtaining a difference between the neighboring green pixel and a current green pixel;
comparing the difference with a predetermined difference threshold;
subdividing the predetermined difference threshold into sections;
determining a section into which the obtained difference is located, thereby determining an index associated with the section where the obtained difference is located; and
obtaining a corresponding weight from the lookup table according to the index.

8. The system of claim 4, wherein the corrected current green pixel is further adjusted by a strength, the strength being dependent on a location of the process mask within an image made of the raw data.

9. The system of claim 8, wherein the strength is determined according to a distance between a center of the process mask and a prime point of the image made of the raw data.

10. The system of claim 9, wherein the larger the distance is, the larger the strength is, and vice versa.

11. A lookup-table-based green imbalance correction method, comprising:
outputting raw data from an image sensor with a color filter array placed over the image sensor;
correcting the raw data according to a lookup table to result in corrected raw data rendered with substantially reduced amount in green imbalance; and
color interpolating the corrected raw data to result in full-color data.

12. The method of claim 11, wherein the color filter array comprises a Bayer color filter array.

13. The method of claim 11, wherein correcting step and/or the color interpolating step is performed or controlled by an image signal processor.

14. The method of claim 11, wherein a current green pixel of the raw data to be currently processed within a process mask to result in a corrected current green pixel is expressed as summation of weighted neighboring green pixels and the current green pixel before being processed, weights associated with the neighboring green pixels within the process mask being looked up from the lookup table.

15. The method of claim 14, wherein the weights associated with the neighboring green pixels are determined according to their differences with the current green pixel, respectively.

16. The method of claim 15, wherein the larger the difference is, the lower the weight is, and vice versa.

17. The method of claim 16, wherein the weight associated with the neighboring green pixel is determined in the following steps:
obtaining a difference between the neighboring green pixel and a current green pixel;
comparing the difference with a predetermined difference threshold;
subdividing the predetermined difference threshold into sections;
determining a section into which the obtained difference is located, thereby determining an index associated with the section where the obtained difference is located; and
obtaining a corresponding weight from the lookup table according to the index.

18. The method of claim 14, wherein the corrected current green pixel is further adjusted by a strength, the strength being dependent on a location of the process mask within an image made of the raw data.

19. The method of claim 18, wherein the strength is determined according to a distance between a center of the process mask and a prime point of the image made of the raw data.

20. The method of claim 19, wherein the larger the distance is, the larger the strength is, and vice versa.
